(19) United States
(12) Patent Application Publication
(10) Pub. No.: US 2006/0283810 A1
(43) Pub. Date: Dec. 21, 2006

(54) A Simplified Device for Converting UV Chambers to an O3/UV Advanced Simultaneous Oxidation Process Reactor for the Treatment of Fluids

(76) Inventors: Vincent J. Ciccone Pe Dee, Woodbridge, VA (US); William E. Kirksey Pe, Woodbridge, VA (US)

Correspondence Address: DR. VINCENT J. CICCONE, PE, 1635-2 WOODSIDE DRIVE, WOODBRIDGE, VA, 22191, US

(21) Appl. No.: 11/276,886

(22) Filed: Mar. 17, 2006

Related U.S. Application Data
(60) Provisional application No. 60/595,272, filed on Jun. 20, 2005.

(51) Int. Cl. C02F 1/32

(52) U.S. Cl. 210/748

(57) ABSTRACT

This application describes a simplified means to convert Commercial-Off-The-Shelf (COTS) ultra-violet light fluid treatment units (chamber) into an improved advanced oxidation process through a mechanism to efficiently introduce ozone (O₃) into the chamber, converting that chamber into an Advanced Simultaneous Oxidation Process (ASOP™) Reactor. This reactor can be used as a stand-alone fluid treatment device or can be combined with other technologies into an integrated treatment system.

### CROSS REFERENCE TO RELATED APPLICATIONS

This Application references and claims priority through Provisional Application No. 60/595,272, filed Jun. 27, 2005 and is related to the Provisional Application No. 60/595,270, “Integrated Advanced Simultaneous Oxidation Process (ASOP) to Defeat Chemical, Biological, and Radiological Agents in Aqueous Solutions”

### FEDERALLY SPONSORED R&D

This invention was made with Government support under CONTRACT DAAD05-03-C-0042 DI-ADMN-81373Task #1403 awarded by the Technical Support Working Group, Combating Terrorism Technology Support Office, Department of Defense. The development of the invention described in this Provisional Patent Application was conducted by the inventors as part of the project “Water Treatment System for Critical Facilities”. The work has been designated as FOUO restricted information by TSWG. The Government has certain rights in the invention.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### REFERENCE TO INFORMATION ON A CD

Not Applicable. There is no CD included with additional information.

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND OF THE INVENTION

The use of use of ozone and Ultra Violet light are well-established means to disinfect fluids such as water and air. The conventional approach is to use these methods either separately or sequentially in combination. Ultra Violet (UV) radiation and ozone (O₃) as an oxidizing agent have been combined for treatment of biological and chemical contamination in water to allow a treatment of a broader range of contaminants than either individually can accomplish. When the treatment uses both O₃ and UV in combination the practice is known as an “Advanced Oxidation Process (AOP).”

Further, most applications of O₃ and UV in combination place the O₃ first in the process stream followed by the UV. This arrangement allows the UV radiation to also serve as an “ozone destruction unit” to prevent significant quantities of O₃ from remaining in the treated solution.

The conventional AOP, introducing the ozone and UV into the fluid stream sequentially, has been demonstrated effective against a range of biological contaminants including bacteria and viruses; however, conventional AOP has been less effective against spores, toxins, and chemical contamination.

The inventors have developed a specific type of device to introduce the ozone directly into the UV chamber. This direct injection allows a simultaneous application of O₃ and UV to the fluid. The simultaneous action of O₃ and UV improves the effectiveness of the overall treatment process well beyond that of the either the separate or sequential approaches and expands the range of contaminants that can be treated. In addition, the device allows treatment of a broader range of fluids (e.g., such as aqueous waste, gases, and contaminated groundwater). The device covered in this present patent application, thus, combines ozone and UV into a simultaneous treatment process and offers a further improvement through a simple method for converting conventional, commercially available, UV Chambers to an O₃ /UV Advanced Simultaneous Oxidation Process (ASOP™) Reactor.

When combined in this manner, the UV catalyzes the O₃ oxidation reaction with the contaminants in the fluid. Further, the O₃ and UV interact as a positive feedback mechanism, each reinforcing the treatment capabilities of the other. This interaction produces overall results greater than the sum of the results of both treatment mechanisms acting independently.

Independent testing has demonstrated that the inventor's Advanced Simultaneous Oxidation Process (ASOP™) Reactor is effective against all types of biological contamination (including bacteria, viruses, spores, and toxins), as well as effective against a wide range of industrial and pharmaceutical chemical contaminants (including military grade chemical weapons, industrial strength chemicals, and hallucinogens).

A separate, provisional Patent Application (No. 60/595,270) filed by the inventors, incorporates the ASOP™ process into an integrated, inline purification technology for aqueous solutions (Hyd-RO-Secure™) that offers multiple functions including defending against chemical, biological, and radiological (CBR) attacks to a facility, providing pure, palatable drinking water (even from contaminated sources) that meets or betters safe drinking water standards, providing high purity water for medical uses, treatment of industrial or municipal waste, or providing emergency treatment in the case of natural or other disaster events.

### BRIEF SUMMARY OF THE INVENTION

This application describes a simplified means to convert Commercial-Off-The-Shelf (COTS) ultra-violet light fluid treatment units (chamber) into an improved advanced oxidation process through a mechanism to efficiently introduce ozone (O₃) into the chamber, converting that chamber into an Advanced Simultaneous Oxidation Process (ASOP™) Reactor.

### BRIEF DESCRIPTION OF THE DRAWINGS

The drawings illustrate the device and the means by which it is integrated with conventional UV lamps and ozone generators used as fluid treatment devices.

FIG. 1 illustrates a front and end view of the ASOP™ Reactor created when the device is installed directly as an integrated system with a UV fluid treatment unit and an ozone generator unit.

FIG. 2 illustrates details of the device in three different configurations, which illustrate some of the most direct ways to configure the device.

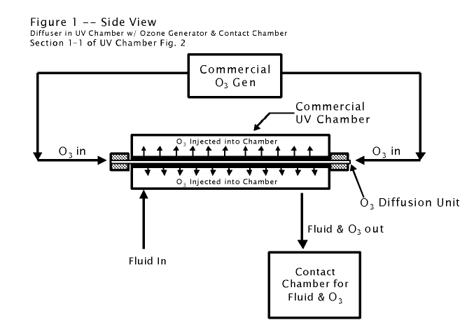

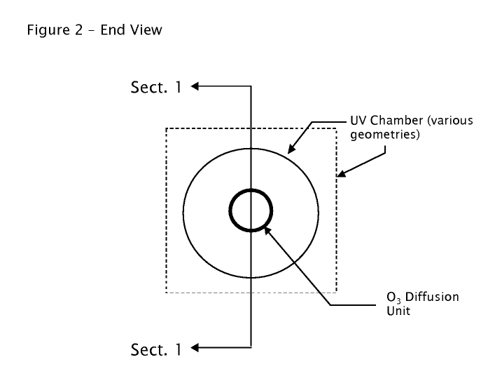

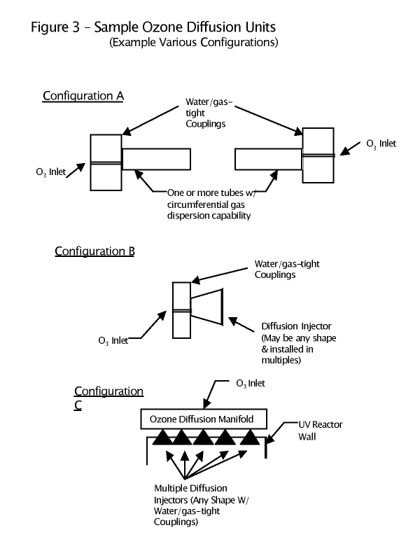

### DETAILED DESCRIPTION OF THE INVENTION

a) Device Description—

This application describes a simplified means to convert a Commercial-Off-The-Shelf (COTS) Ultra-Violet Light for fluid treatment into an improved advanced oxidation process through a particular means of directly introducing ozone (O₃) directly into the UV chamber. As noted, the conventional approaches to the combined use of ozone and UV introduce the ozone and UV into the fluid stream sequentially. The device internally injects the ozone directly into the UV chamber under pressure, at a controlled rate that enhances O₃ dispersion in the reactor chamber.

The device includes:
A means of conveying the ozone supply to the UV treatment vessel;
A means of creating a fluid/gas-tight connection to an opening in the UV treatment vessel;
A means of internally injecting the O₃ into the UV chamber.

Further, if desired, the device can include electronic sensors and controls connected to a programmable logic controller for efficient utilization of the O₃ generator.

All components of the device can be provided in a variety of ways. This Provisional Patent Application covers all means of providing these functioning components. For example, as appropriate to the intended use, the conveyance of the ozone may be accomplished by a hose or pipe of any ozone resistant material of appropriate size; the fluid/gas-tight connection may be achieved through any combination of threads, fittings, or gaskets of any ozone resistant material; and the internal injection of ozone into the UV chamber may be accomplished by any combination of spargers, bubblers, nozzles, a circumferential plenum, or perforated tubes or pipes of any number and configuration.

The reactor may be used as a stand-alone treatment, a supplement to a conventional treatment process, or as an integrated component in a single or multi purpose-built treatment system. As an example of the latter case, the reactor is integrated into a full treatment process designed by the inventors and described in Provisional Patent Application No. 60/595,270. The resulting treatment system for aqueous solutions offers broad-based, cost-effective treatment capability across a wide range of credible contamination threats.

The ASOP™ reactor system may operate with or without a programmable logic controller to integrate system function and sequencing. Such a controller also provides system monitoring, both on site and remotely, and allows data logging to store and compile reports of operation for later operator/management analysis. In addition to this fully automated operational mode, the system may be configured to operate in a manual mode with varying degrees of monitoring information and alarm indications provided by the individual unit components depending on operating needs.

b) Covered Applications of the Invention

The process described in Section 8, a) can be applied in a variety of configurations, the use of which are included in this application. In particular, likely applications of this process include:
(1) Permanent, fixed installations designed to serve and protect existing or new facilities such as government buildings, institutional buildings or campuses, commercial buildings (e.g. hotels, shopping malls, amusement parks, etc.), sports arenas or facilities, or other public icon facilities.
(2) Mobile, skid-mounted systems that can be mass-produced and transported as a self contained unit to be installed on short notice for protection at specific sites (e.g., military bases, overseas government facilities, overseas civilian facilities).
(3) Mobile systems mounted on a truck or trailer (including systems configured with a self contained power generator) for deployment in emergency conditions to provide disaster relief, rapid clean up after events that contaminate community water supplies, clean up of accidental release of wastewater and industrial spills, and supplemental water treatment during temporary water shortages due to events such as electrical outages, equipment malfunction, or facility damage.
(4) Tailored systems developed for specific fluid treatment purposes, for example medical, agricultural, or industrial usage, in which post-treatment equipment may be added to the system to provide for facility specific usage.
(5) Packaged systems designed to be integrated with HVAC air handling equipment to provide protection from air borne threat agents or contaminants.
(6) Wastewater treatment systems integrated with appropriate pre-treatment and tuned to provide appropriate UV radiation wavelengths for the particular waste stream.

c) Construction of the System

The COTS components of the system consist of an ozone generator, a UV fluid treatment unit, and a variety of hoses, pipes, valves, and fittings. These components are supplemented with the specific diffusion device selected for a particular use, which may have to be fabricated depending on specific requirements. These components are then assembled using the conventional practices of mechanical, electrical, and plumbing construction, in the following configuration:
(1) The output of the ozone generator is directed into a compressor to boost the pressure to desired levels.
(2) The pressurized ozone stream is then directed through a fitting and into a hose or pipe leading to the internal injector/diffuser.
(3) The hose or pipe may have a T-connection or connect into a manifold for dispersal to a single or multiple internal injector(s) or diffusion device(s).
(4) The hose or pipe will connect to a fluid/gas-tight fitting configured to allow the O₃ to pass through an aperture in the UV chamber and into the diffusion device.
(5) The incoming fluid channel will be connected to the inlet of the UV chamber.
(6) The diffusion device(s) will be connected to the fluid/gas-tight fitting on the inside of the UV chamber in such a way that the O₃ is able to pass through the wall of the chamber, through the internal injector/diffuser, and into the UV chamber.
(7) The fluid outlet of the device will be directed through appropriate piping and fittings into a contact tank sized to provide the appropriate contact time for the intended use.
(8) Depending on the intended use, electronic sensors and control circuits can be connected to a programmable logic controller to automate dosage rates, concentrations, and treatment cycles.

The device described can vary widely in size and resulting treated product fluid volume, cost-effectively ranging on the low end from 1 to 5 units per minute to several 100 units per minute on the high end. Depending on the physical space available for the system and logistic considerations, multiple modules can be more appropriate than one large one.

What is claimed is:

1. The capability to purify fluids (e.g., drinking water, HVAC distributed air, waste fluid streams, etc.) by simultaneously introducing ozone and UV into the fluid, in such a way as to produce a solution rich in ozone during simultaneous exposure to the UV radiation. This combined ozone and UV device (ASOP™) for treating chemical and biological contaminants in fluids includes the functions:
a. Generating ozone employing one or more ozone generator units, either using oxygen from an air-based generator or from a compressed oxygen supply tank, and capable of maintaining a desired concentration of ozone in the reactor vessel
b. Compressing the ozone stream to achieve the desired pressure for injection of the ozone into the UV chamber
c. Delivering UV radiation to the fluid stream in a specified range of wavelengths (depending on the intended use) using a conventional and available ultra violet fluid treatment unit (UV Reactor)
d. Connecting an ozone generator to a diffusion device in the UV Reactor vessel by use of a conduit (hose or pipe)
e. Injecting the ozone into the UV Reactor using one or more internal injectors or diffusion devices inside the UV Reactor vessel and connected to the ozone supply through a fluid/gas-tight fitting
f. Allowing appropriate reaction time, and time to deplete the ozone by directing the fluid flowing out of the Reactor into a contact tank sized appropriately.

2. The ability to provide automated control for the combined ozone and UV fluid treatment device of claim 1, through the use of electronic sensors and control circuits connected to a programmable logic controller (PLC). The PLC could control such factors as dosage concentrations, rates, and treatment cycles, and could communicate with other parts of a fluid treatment or building security system. Such a controller also could provide system monitoring, both on-site and remotely, and data logging to store and compile reports of operation for later operator/management analysis.

3. The capability to allow treatment of specific characteristics of incoming fluids by integrating the combined ozone and UV fluid treatment device of claim 1, with other pre-treatment units. These units could include screens, particulate filters, carbon beds, minerals for the adjustment of chemical characteristics, electrostatic precipitators, or other devices to physically and chemically prepare the incoming fluid for the treatment process.

4. The capability of integrating the combined ozone and UV fluid treatment device of claim 1, with other treatment components into an integrated fluid treatment system. These other components could include such devices as membrane based units, or a completely integrated system such as is outlined in the related Provisional Patent Application No. 60,595,270, “Integrated Advanced Simultaneous Oxidation Process (ASOP) to Defeat Chemical, Biological, and Radiological Agents in Aqueous Solutions”.

5. The ability to add post-treatment units to the combined ozone and UV fluid treatment device of claim 1, designed to condition the product fluid to meet the specific needs of the user.

6. The ability to integrate the combined ozone and UV fluid treatment device of claim 1, with the options described in claims 2 through 5, or with any combination of those options.

7. The capability of creating a self contained unit incorporating the combined ozone and UV fluid treatment device of claim 1, including power from a portable electric generator (either fossil fuel based or renewable energy based), and mounted in a wheeled vehicle (trailer, van, rail car, or truck) or any suitable vessel for mobile deployment and operation.

8. The capability of creating packaged systems to be integrated with building or vehicle HVAC systems to clean the incoming air stream or to clean exhaust air from laboratories, factories, vehicles or other sources of air pollution.

9. The ability to mount the combined ozone and UV fluid treatment device of claim 1, in a surface or undersea vessel to provide shipboard potable water, decontaminate wastewater, or to provide protection from air borne threat agents in the HVAC systems.

10. The capability of configuring the combined ozone and UV fluid treatment device of claim 1, as a skid mounted, self-contained unit, designed for air, rail, water vessel, or truck transport and delivery.

11. The ability to configure the combined ozone and UV fluid treatment device of claim 1, for use of solar radiation to provide the Ultra Violet radiation to the reactor chamber.
